(19) United States
(12) Patent Application Publication
(10) Pub. No.: US 2025/0299372 A1
(43) Pub. Date: Sep. 25, 2025

(54) INFORMATION ENCODING APPARATUS AND METHOD, INFORMATION DECODING APPARATUS, AND STORAGE MEDIUM

(71) Applicant: CANON KABUSHIKI KAISHA, Tokyo (JP)

(72) Inventor: KAORU OZAKI, Tokyo (JP)

(21) Appl. No.: 19/074,818

(22) Filed: Mar. 10, 2025

(30) Foreign Application Priority Data
Mar. 21, 2024 (JP) 2024-045343

(51) Int. Cl. G06T 9/00

(52) U.S. Cl. CPC G06T 9/00

(57) ABSTRACT

An information encoding apparatus includes a first encoding unit configured to encode the image information, a second encoding unit configured to encode the haptic information, the second encoding unit including an analysis unit configured to analyze a correlation between the image information and the haptic information, a generation unit configured to generate pixel value conversion information that is information for converting a pixel value into a conversion pixel value, a calculation unit configured to calculate a difference value between a haptic signal value and the conversion pixel value corresponding to a same spatial position as the haptic signal value, and an encoding unit configured to encode the difference value; and a multiplexing unit configured to multiplex image encoded data, haptic encoded data, and the pixel value conversion information into one bit stream.

### BACKGROUND OF THE INVENTION

### Field of the Invention

The present invention relates to an information encoding apparatus configured to encode image information and haptic information.

### Description of the Related Art

In recent years, there are increasing opportunities allowing a user wearing a head-mounted display or the like to experience video with a high sense of reality and a high sense of presence even if the user is not present at the place in real time. Furthermore, in order to provide a higher sense of existence to the user, a function of feeding back haptic information in addition to images and audio has started to be used.

Therefore, it is necessary to transmit and accumulate a large amount of data such as images, audio, and haptic information more efficiently than before. In this regard, Japanese Patent Laid-Open No. 2014-239430 discloses a technique in which image information, audio information, and haptic information are encoded by different compression methods, and then processed into one stream and output by a multiplexer in a subsequent stage.

However, in the configuration of the known technique, since each piece of information is encoded separately, there remains a problem that it is difficult to achieve high compression performance depending on content.

### SUMMARY OF THE INVENTION

The present invention has been made in view of the above-described problem, and provides an information encoding apparatus that can efficiently encode image information and haptic information.

According a first aspect of the present invention, there is provided an information encoding apparatus configured to encode image information and haptic information, the information encoding apparatus comprising: at least one processor or circuit and a memory storing instructions to cause the at least one processor or circuit to perform operations of the following units: a first encoding unit configured to encode the image information; a second encoding unit configured to encode the haptic information, the second encoding unit including an analysis unit configured to analyze a correlation between the image information not encoded and the haptic information not encoded, a generation unit configured to generate pixel value conversion information that is information for converting a pixel value in the image information not encoded into a conversion pixel value that is a different pixel value based on an analysis result by the analysis unit, a calculation unit configured to calculate a difference value between a haptic signal value in haptic information and the conversion pixel value corresponding to a same spatial position as the haptic signal value, and an encoding unit configured to encode the difference value; and a multiplexing unit configured to multiplex image encoded data encoded by the first encoding unit, haptic encoded data encoded by the second encoding unit, and the pixel value conversion information into one bit stream.

According to a second aspect of the present invention, there is provided an information decoding apparatus configured to decode the bit stream generated by the information encoding apparatus according to claim 1, the information decoding apparatus comprising: at least one processor or circuit and a memory storing instructions to cause the at least one processor or circuit to perform operations of the following units: a separation unit configured to acquire the image encoded data, the haptic encoded data, and the pixel value conversion information from the bit stream; a first decoding unit configured to decode the image encoded data; and a second decoding unit configured to decode the haptic encoded data, including a unit configured to decode the difference value having been encoded, a second conversion unit configured to convert a pixel value decoded by the first decoding unit by using the pixel value conversion information, and an addition unit configured to add a pixel value converted by the second conversion unit and the difference value having been decoded.

According to a third aspect of the present invention, there is provided an information encoding method of encoding image information and haptic information, the information encoding method comprising: executing first encoding of encoding the image information; executing second encoding of encoding the haptic information, the second encoding including analyzing of analyzing a correlation between the image information not encoded and the haptic information not encoded, generating of generating pixel value conversion information that is information for converting a pixel value in the image information not encoded into a conversion pixel value that is a different pixel value based on an analysis result by the analyzing, calculating of calculating a difference value between a haptic signal value in haptic information and the conversion pixel value corresponding to a same spatial position as the haptic signal value, and encoding of encoding the difference value; and executing multiplexing of multiplexing image encoded data encoded by the first encoding, haptic encoded data encoded by the second encoding, and the pixel value conversion information into one bit stream.

Further features of the present invention will become apparent from the following description of exemplary embodiments with reference to the attached drawings.

### BRIEF DESCRIPTION OF THE DRAWINGS

FIG. 1 is a system configuration diagram of an information compression apparatus 100 in a first embodiment.

FIG. 2 is an internal configuration diagram of an information compression encoding unit 103 in the first embodiment.

FIG. 3 is a flowchart showing an operation of the information compression encoding unit 103 in the first embodiment.

FIGS. 4A and 4B are views illustrating a correspondence relationship between pixel information and haptic information in the first embodiment.

FIG. 5 is a view showing specific examples of pixel values and haptic signal values in the first embodiment.

FIG. 6 is a view showing specific examples of pixel values and pixel values after conversion in the first embodiment.

FIGS. 7A to 7E are views illustrating specific examples of corresponding pixel values, haptic signal values, pixel value converted data, and difference values in the first embodiment.

FIG. 8 is a data structure diagram of a multiplexed bit stream in the first embodiment.

FIG. 9 is a view illustrating a format example of pixel value conversion information transmitted as header data in the first embodiment.

FIG. 10 is a view illustrating a format example of haptic encoded data in the first embodiment.

FIG. 11 is a view showing specific examples of pixel values and haptic signal values in a second embodiment.

FIGS. 12A and 12B are flowcharts showing an operation of the information compression encoding unit 103 in the second embodiment.

FIG. 13 is a conceptual diagram illustrating a change of an encoding target object in a third embodiment.

FIGS. 14A and 14B are flowcharts showing an operation of the information compression encoding unit 103 in the third embodiment.

FIG. 15 is a view illustrating a stream structure in the third embodiment.

FIG. 16 is a system configuration diagram of a decoding reproduction apparatus 1600 in a fourth embodiment.

FIG. 17 is a function block configuration diagram of an information decoding unit 1603 in the fourth embodiment.

FIG. 18 is a flowchart showing an operation of the information decoding unit 1603 in the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### System Configuration

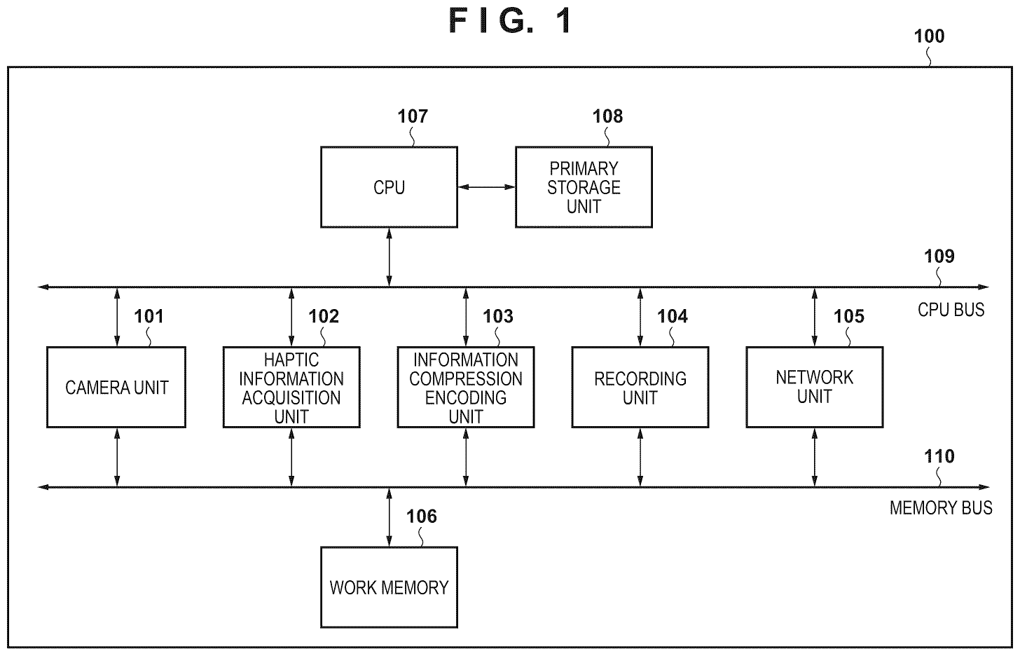

FIG. 1 is a block diagram illustrating a system configuration example of the information compression apparatus (information encoding apparatus) 100 according to the first embodiment of the present invention.

The system of the present embodiment is configured to include a camera unit 101, a haptic information acquisition unit 102, an information compression encoding unit 103, a recording unit 104, a network unit 105, a work memory 106, a central processing unit (CPU) 107, a primary storage unit 108, a CPU bus 109, and a memory bus 110.

The camera unit 101 includes a camera unit and an optical unit including a lens, an image capturing element, and the like (not illustrated), converts an optical signal taken in from the lens into an electric signal by the image capturing element, and generates a RAW image of a Bayer format for one frame, for example. Furthermore, processing such as optical correction, noise removal, blur correction, white balance correction, and color conversion is performed on the RAW image, and then the RAW image is output and stored, as image information in RGB format or YUV format, to the work memory 106 including a large-capacity DRAM via the memory bus 110.

The haptic information acquisition unit 102 includes, for example, a piezoelectric element, which is a sensor using a piezoelectric effect, and converts, into an electric signal, an analog signal at the time of sensing with respect to an arbitrary or specific haptic target. Then, a digital signal value obtained by allocating this electric signal to a range that can be expressed by a predetermined bit number is output as haptic information.

Note that it is assumed that the haptic information in the present embodiment is obtained by sensing a physical quantity that continuously changes, that is, a physical quantity that can be recognized as what is called haptic sensation by a human, such as warm/cool and dry/wet, in addition to soft/hard by pressure and vibration, and any one physical quantity may be handled or physical quantities may be handled in combination.

Haptic information may be virtually generated from image information of a haptic target without actually performing physical haptic sensing. Haptic information may be acquired by applying the deep learning technology disclosed in, for example, Non-Patent Document 1 (Takashi TAKAHASHI and one other person, “Deep visuo-tactile learning: Estimation of Tactile Properties from Images” [online], Jul. 9, 2019 in IEEE International Conference on Robotics and Automation (ICRA), 2019, Internet <URL:https://arxiv.org/pdf/1803.03435.pdf>), using a haptic model in which an image and the haptic information, and inferring the haptic information from image information.

Furthermore, the haptic information handled in the present embodiment is configured such that one piece of haptic information per pixel corresponds to the image information acquired by the camera unit 101, and is handled such that the positions in the two-dimensional space of the haptic information and the image information coincide with each other. The haptic information generated as described above is output to and stored in the work memory 106.

The information compression encoding unit 103 reads image information and haptic information from the work memory 106, performs compression encoding, and generates a bit stream in which compressed data is multiplexed. The bit stream is written to the work memory 106.

The recording unit 104 reads the bit stream from the work memory 106 and writes the bit stream into a storage device such as a nonvolatile memory represented by a USB, an SD card, a hard disk drive, or a flash memory.

The network unit 105 is an interface for connecting the information compression apparatus 100 and an external apparatus. Then, in the present embodiment, a bit stream mainly stored in the work memory 106 is read, and the bit stream is transmitted by communicating with an external apparatus via a network.

As the network described above, the Internet, a local area network (LAN), a wide area network (WAN), a public line, or the like may be applied. That is, the method may be any method as long as it can establish transmission and reception of information with the information compression apparatus 100 and is not particularly limited. The network may be a wireless network or a wired network. Furthermore, a plurality of different types of networks may be included.

The CPU 107 controls the camera unit 101, the haptic information acquisition unit 102, the information compression encoding unit 103, the recording unit 104, and the network unit 105 constituting the system of the present embodiment, such as start, stop, and interrupt notification, via the CPU bus 109, and controls various operations of the entire information compression apparatus 100.

The primary storage unit 108 is a storage area used as a work area or the like of the CPU 107. The primary storage unit 108 is implemented by, for example, a dynamic random access memory (DRAM), a static random access memory (SRAM), a nonvolatile flash memory, or the like. For example, the CPU 107 loads and executes a control program stored in the primary storage unit 108, thereby implementing various functions provided by the information compression apparatus 100.

The CPU bus 109 is a control bus connecting the CPU 107 and each of the above-described processing blocks, and a standardized bus standard method similar to the memory bus 110 described later may be used, or a serial method such as a low-speed I2C may be used if there is a sufficient processing margin. In the present embodiment, the method is not particularly limited.

The memory bus 110 is a data bus for connecting, with the work memory 106, the camera unit 101, the haptic information acquisition unit 102, the information compression encoding unit 103, the recording unit 104, and the network unit 105, and transferring image data and various types of parameter data at a high speed. As the bus transfer method, a standard bus standard such as ISA, PCI-Express, or AXI may be used, or a unique bus method may be used, and there is no particular limitation in the present embodiment.

### Internal Configuration of Information Compression Encoding Unit

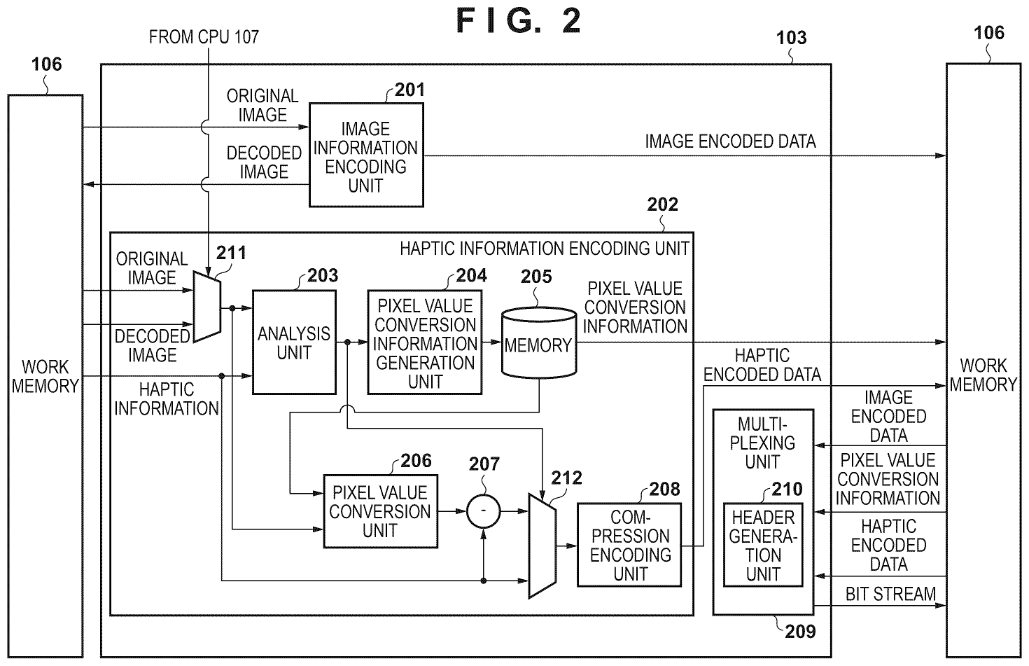

Next, FIG. 2 is a view illustrating an internal configuration of the information compression encoding unit 103, which is a characteristic configuration of the present embodiment. Hereinafter, internal processing of the information compression encoding unit 103 will be described with reference to FIG. 2.

The information compression encoding unit 103 is configured to include an image information encoding unit 201, a haptic information encoding unit 202, and a multiplexing unit 209.

The image information encoding unit 201 reads, as an original image, image data recorded by the camera unit 101 stored in the work memory 106, performs image compression encoding based on standards such as H. 264 and HEVC, and writes encoded data into the work memory 106.

In the present embodiment, the image information encoding unit 201 has a configuration in which decoded image information temporarily generated for a reference image in the process of compression processing, that is, what is called a local decoded image is output as it is to the work memory 106 without being held or discarded inside the encoding unit, and can be used by the haptic information encoding unit 202 described later. Furthermore, for what is called a B picture that is a non-reference picture, although it is unnecessary to output a local decoded image as an original encoding application, it is assumed that the local decoded image is similarly output in order to achieve the operation of the present embodiment described later.

The haptic information encoding unit 202 is configured to include an analysis unit 203, a pixel value conversion information generation unit 204, a memory 205, a pixel value conversion unit 206, a subtractor 207, a compression encoding unit 208, a selector 211, and a selector 212.

To the analysis unit 203, image information in which either an original image acquired by the camera unit 101 from the work memory 106 or a decoded image processed by the image encoding unit 201 is selected via the selector 211, and haptic information output from the haptic information acquisition unit 102 are input. Then, the analysis unit 203 analyzes the correlation between the image information and the haptic information. Then, the analysis unit 203 notifies the pixel value conversion information generation unit 204 and the selector 212 present at the subsequent stage of the subtractor 207 of the analysis result. Detailed internal operation of the analysis unit 203 will be described later.

Here, a selection control signal of the selector 211 is assumed to be set by the CPU 107. Then, for example, it is assumed that switching can be performed mainly by software processing in units of series of content (hereinafter called a sequence in the present embodiment) from photography record to stop triggered by a user operation not illustrated or in units of pictures.

For example, when a B picture is encoded by the image encoding unit 201 described above, the decoded image is not output to the work memory 106, and the selector 211 selects an original image input at the time of encoding the corresponding haptic information. Alternatively, when lossless compression, a low compression rate mode, or the like is set as the operation mode, and there is no quantization error between the original image and the decoded image or the quantization error is equal to or less than a predetermined value, control such as selecting the original image input is preferable. By doing this, it is possible to flexibly design and optimize the memory access of the information compression encoding unit 103.

Based on the result of the analysis unit 203, the pixel value conversion information generation unit 204 generates and stores, in the memory 205, pixel value conversion information for converting the value of the image information into a value close to the value of the haptic information. A detailed internal operation of the pixel value conversion information generation unit 204 will be described later.

The memory 205 has the same configuration as the primary storage unit 108 and the work memory 106, and temporarily stores the information output by the pixel value conversion information generation unit 204.

In the present embodiment, the memory 205 is included inside the haptic information encoding unit 202 for the purpose of simplifying the controllability of the haptic encoded data output by the subsequent compression encoding. However, when the conversion information exceeds the capacity of the memory 205 and when a memory band related system operation failure will not occur, the conversion information may be stored in the work memory 106.

However, when the conversion information is stored in the work memory 106 not via the memory 205 described above, the conversion information is read from the work memory 106 again in the direction of a data path not illustrated and is input to the pixel value conversion unit 206 described later.

The memory 205 may have a configuration included inside the pixel value conversion information generation unit 204, and is not particularly limited in the present embodiment as long as the same effect can be obtained.

The pixel value conversion unit 206 performs pixel value conversion of the image information with the image information output from the selector 211 and the pixel value conversion information read from the memory 205 as inputs.

The subtractor 207 inputs the pixel value converted data output from the pixel value conversion unit 206 and the haptic information corresponding to the same spatial position read from the work memory 106, and calculates a difference.

The selector 212 uses, as a selection control signal, a signal indicating the existence or absence of the correlation notified from the analysis unit 203, outputs the difference input from the subtractor 207 when there is the correlation, and outputs the haptic information read from the work memory 106 when there is no correlation.

The compression encoding unit 208 performs, as an input, compression encoding using the difference value or the haptic information value output from the selector 212 at the preceding stage.

A compression encoding algorithm executed by the compression encoding unit 208, similarly to the image information encoding unit 201, is applied with a hybrid method for reducing spatial redundancy and temporal redundancy using frequency conversion and frame prediction based on a standard such as H. 264 or HEVC.

Note that in the present embodiment, the image information encoding unit 201 and the compression encoding unit 208 inside the haptic information encoding unit 202 are implemented as different component configurations. However, in a case of the same configuration at an individual encoding tool level such as prediction processing, frequency conversion, quantization, and entropy encoding processing inside the encoding unit not illustrated, the image information encoding unit 201 and the compression encoding unit 208 inside the haptic information encoding unit 202 may be shared as one apparatus configuration.

When the difference value from the subtractor 207 is input, the prediction processing may be omitted, and the processing steps inside the encoding unit may be appropriately switched to performing of only frequency conversion, quantization, and entropy encoding processing.

On the other hand, when haptic information is directly input to the compression encoding unit 208, the prediction processing is not omitted, and the compression encoding is performed by applying an encoding processing step similar to that of the image information.

The multiplexing unit 209 reads the image encoded data, the haptic encoded data, and the pixel value conversion information from the work memory 106, adds header information described later, multiplexes the data, and outputs a bit stream.

A header generation unit 210 is installed in the multiplexing unit 209, and embeds (describes), into the header, necessary information (encoding control information) prior to actual compressed encoded data so that the bit stream generated by the information compression apparatus 100 can be correctly decoded by a decoding reproduction apparatus outside the apparatus. Details of the content of the header information generated by the header generation unit 210 and the generation method will be described later.

The function of the information compression encoding unit 103 described so far is implemented by dedicated hardware such as a digital signal processor (DSP) or wiring logic, and is a configuration assuming that high-speed real-time processing is performed. However, the method is not particularly limited as long as it can implement equivalent functions and performance by the software processing of the CPU 107.

The above is the internal configuration of the information compression encoding unit 103 in the present embodiment and the functional outline thereof.

### Operation Flow of Information Compression Encoding Unit

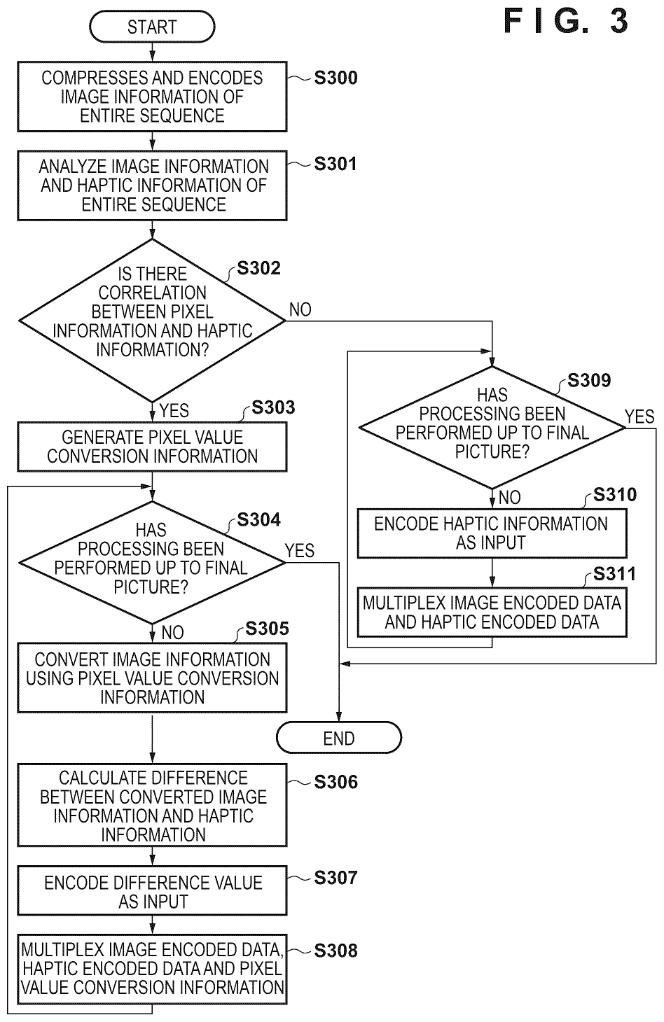

Next, FIG. 3 is a flowchart showing the operation in the information compression encoding unit 103. Note that unless otherwise specified in the present operation flow, execution, determination, and state transition of the processing steps are performed by control such as start and stop from the CPU 107 to each function block described above.

This operation flow is started in the information compression apparatus 100 from the timing when the camera unit 101 and the haptic information acquisition unit 102 complete recording of all data of image information and haptic information constituting the above-described “sequence” in the work memory 106 or the recording unit 104.

First, in step S300 (hereinafter, “step” is omitted), the image information encoding unit 201 reads the original image from the work memory 106 picture by picture, and compresses and encodes the image information of the entire sequence.

In S301, the analysis unit 203 reads the image information and the haptic information from the work memory 106, and derives the correlation between the image information and the haptic information. At this time, selection determination of whether to input the decoded image or to input the original image as the image information is as described above, and the processing content of the present step is the same.

Here, details of the analysis processing performed in S301 will be described.

### Processing Content of Analysis Unit 203

The analysis target in the analysis unit 203 is assumed to be an image of the entire sequence and haptic information. For all the pixels in which the spatial positions of the haptic information and the image information constituting the entire sequence coincide, it is determined whether or not each signal value has a relationship in which the other signal value is determined if one is determined, that is, whether or not there is a correlation.

The determination of the existence or absence of the correlation between the image information and the haptic information in the present embodiment is performed by obtaining a correlation coefficient r of two variables based on the following calculation expression (1), which is generally used in the field of statistics, for example.

$$r = \frac{\frac{1}{n} {\sum }_{i = 1}^{n} ( {x}_{i} - \overline{x} ) ( {y}_{i} - \overline{y} )}{\sqrt{\frac{1}{n} {\sum }_{i = 1}^{n} {( {x}_{i} - \overline{x} )}^{2}} \sqrt{\frac{1}{n} {\sum }_{i = 1}^{n} {( {y}_{i} - \overline{y} )}^{2}}} \qquad ( 1 )$$

In the above expression (1), r is a correlation coefficient, x is a haptic value of the haptic information, y is a pixel value of the image information, and n is the total number of pixels and haptic information in the entire sequence.

A subscript i of x and y indicates i-th pixel information or haptic information in the sequence, x indicates an arithmetic mean of x, and y̅ indicates an arithmetic mean of y. The value range of r is indicated by a value between −1 and +1, and it can be determined that there is no correlation as the value of r is closer to 0. The content of the analysis processing executed in S301 has been described above.

Returning to the description of the flowchart of FIG. 3, in S302, the existence or absence of correlation is determined for the analysis result in S301. If it is determined that there is a correlation (YES in S302), the process moves to S303, and if it is determined that there is no correlation (NO in S302), the process moves to S309.

Here, in the present embodiment, a specific value is not particularly limited. However, as the threshold of existence or absence of correlation, for example, when the absolute value of the correlation coefficient r described above is from 0.8 to 0.9 or more, it is determined that there is a correlation between the pixel information and the haptic information.

In S303 in which it is determined that there is a correlation between the image information and the haptic information, the pixel value conversion information generation unit 204 generates pixel value conversion information.

### Processing Content of Pixel Value Conversion Information Generation Unit 204

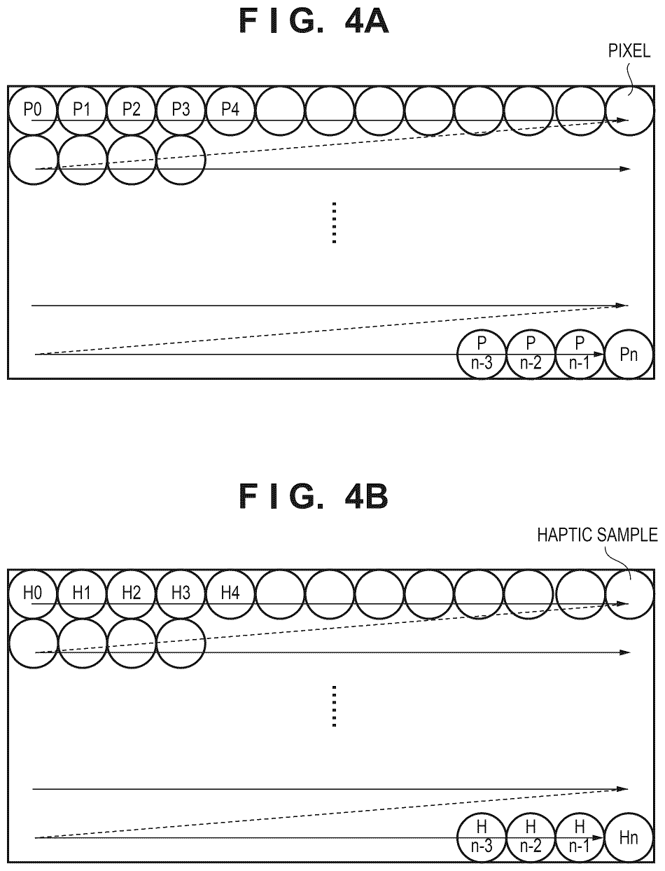

Here, the processing content of the pixel value conversion information generation unit 204 will be described with reference to FIGS. 4A, 4B, 5, and 6.

FIGS. 4A and 4B are diagrams illustrating a correspondence relationship between haptic information and image information in a two-dimensional space. FIG. 4A is a view of image information for one picture generated by the camera unit 101, and has pixel values in units of one pixel and is stored in raster order.

FIG. 4B illustrates the haptic information of one picture generated by the haptic information acquisition unit 102, has the haptic signal value with the information granularity of the area and resolution corresponding to one pixel unit same as the image information, and is stored in raster order. Hereinafter, in the present embodiment, an information unit of a haptic signal is called a “haptic sample” for convenience.

In the pixel information, each pixel is given a label for identifying a spatial position starting from P0, and similarly, in the haptic information, each haptic sample is given a label for identifying a spatial position starting from H0. Then, by specifying the label, it is possible to uniquely determine where the label is spatially positioned.

In the present embodiment, for simplification of description, identification is performed by the above-described labeling. However, a method that can uniquely specify which pixel or which haptic sample by what is called xy two-dimensional coordinates including two-dimensional horizontal address value and vertical address value may also be used.

Thus, in the present embodiment, the pixel P0 and the haptic sample H0 correspond to each other. Then, the positions of the pixel and the haptic sample correspond to each other in the entire area up to Pn and Hn in such a manner that the pixel P1 and the haptic sample H1 correspond to each other similarly.

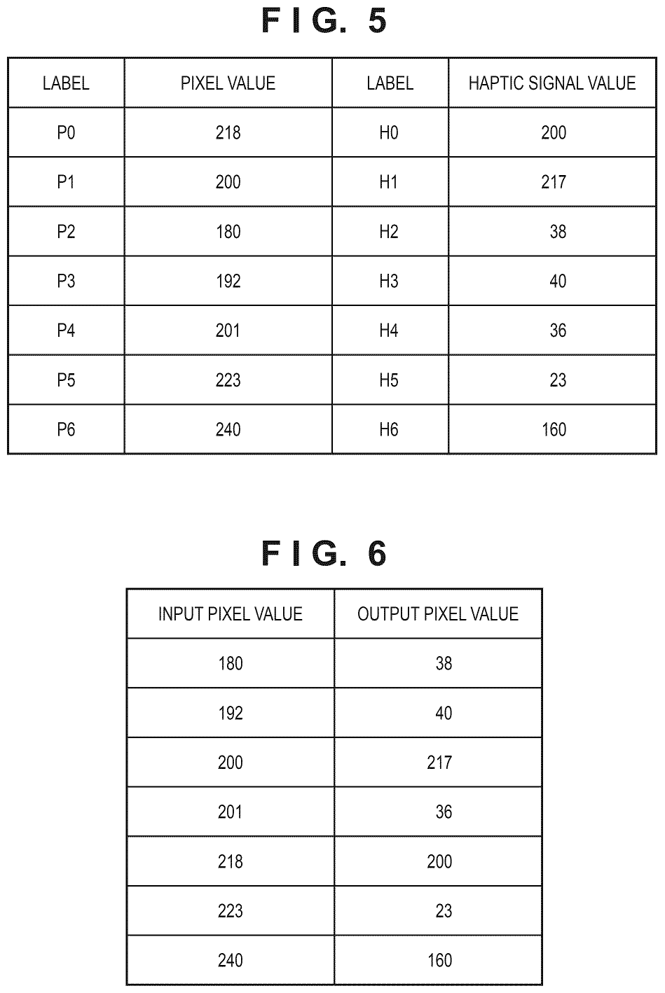

Specific examples of the pixel value and the haptic signal value acquired based on the arrangement of the pixel information and the haptic information described above are shown in FIG. 5 as a table.

In the example of FIG. 5, for simplifying the description, spatially corresponding pairs of the seven pixel values and haptic signal values are expressed in a table format, and correspond to only a part of the pixels and the haptic information of the entire actual sequence.

Specifically, the haptic signal value corresponding to 218 of the pixel value P0 is 200 of H0, and the haptic signal value corresponding to 200 of the pixel value P1 is 217 of H1. Hereinafter, specific values up to P6 and H6 are similarly shown.

Then, in FIG. 6, an example of the image value conversion information generated in S303 by determining that there is a correlation in the above-described S302 for the signal value of FIG. 5 and is shown in a table format.

The pixel value conversion information in FIG. 6 has a data structure in what is called a lookup table format in which when an input pixel value in the first column is designated as an index, an output pixel value in the second column is obtained as pixel value converted data.

Therefore, the pixel values from P0 to P6 in FIG. 5, which is the original, actually including the pixel values of the entire sequence other than them are sorted in ascending order, and used as input values so that index search can be performed as they are. As a result, the haptic signal values of H0 to H6 corresponding to respective pixels and the entire subsequent sequence are data-shaped so as to be output as pixel value converted data.

In the present embodiment, the above-described lookup table is called pixel value conversion information, and is output from the pixel value conversion information generation unit 204.

While a method of implementation using a lookup table is given, the present invention is not necessarily limited to the same data structure, and may be implemented by other means as long as a similar effect can be expected.

Note that in the present embodiment, in the examples of FIGS. 5 and 6, it is assumed that the pixel value is a numerical value of 0 to 255, and the haptic signal value is information having a range of 0 to 255. However, when the pixel value and the haptic signal value have different bit depths, the bit depths are made uniform by a known operation such as bit extension.

Here, returning to the description of the flowchart of FIG. 3 again, in S304, it is determined whether the processing has been performed up to the final picture. If the processing has not been performed up to the final picture (NO in S304), the process transitions to S305, and the similar processing in and after S304 is performed on the next picture. On the other hand, if the processing has been performed (YES in S304), it can be determined that the encoding of the haptic information has been completed for all the pictures in the sequence, and thus, the present flow ends.

In S305, the image information is converted using the pixel value conversion information generated in S303, and the converted image information is output.

In subsequent S306, a difference between the converted image information and the haptic information is calculated.

### Detailed Description of Difference Value

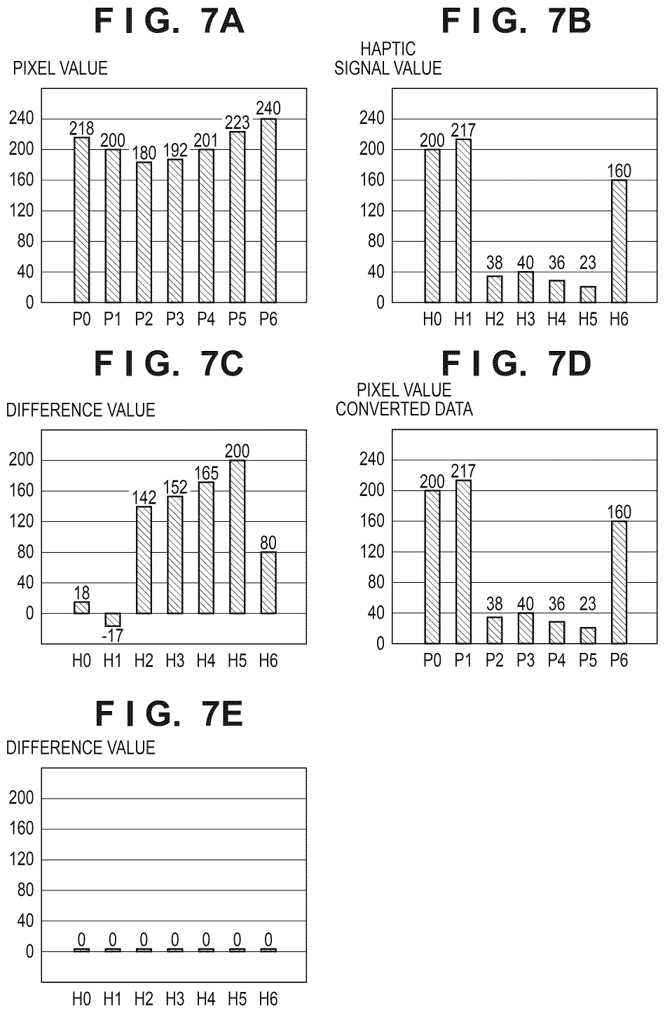

Here, the difference value after passing through the subtractor 207 executed in S306 and the compression efficiency improvement mechanism, which is a feature of a series of the present embodiment, will be described with reference to FIGS. 7A to 7E.

FIG. 7A is a graph of pixel values of FIG. 5, FIG. 7B is a graph of haptic signal values of FIG. 5, and FIG. 7C is a graph of difference values in which the haptic signal values are subtracted from the pixel values of FIG. 5. FIG. 7D is a graph of the pixel value converted data of FIG. 6 generated in S305, and FIG. 7E is a graph of the difference values in which the haptic signal values of FIG. 5 are subtracted from the pixel value converted data of FIG. 6.

The vertical axes of the graphs represent the pixel values and the haptic signal values, and the horizontal axes represent the labels described in FIGS. 4A and 4B described above, and indicate the raster order position in the two-dimensional space in the present embodiment.

As seen by visualizing as graphs in this manner, FIGS. 7C and 7E are both graphs of difference values, but the difference values in FIG. 7E, which are difference values applied with the pixel value conversion information by the present embodiment, can be made smaller than those in FIG. 7C.

As for the pixel information of the label P4 in FIG. 5, when the pixel value is 201 and the haptic signal value is 36, the pixel value conversion information is converted with 36 as an output value if 201 is an input value. By converting the pixel value into a value (conversion pixel value) in the vicinity of the haptic signal value using the characteristic that the correlation between the pixel information and the haptic information is high, the input to the subtractor 108 at the subsequent stage has 36 as a value after the pixel value conversion, the haptic signal value 36, and the result after the subtraction is 0.

Here, even if difference calculation is simply performed as it is based on the determination result that there is a correlation between the haptic information and the pixel information, the data distribution characteristics are different. Therefore, the result illustrated in FIG. 7C is obtained, and the difference is not necessarily small. Therefore, in the present embodiment, the pixel value conversion information generation unit 204 performs processing of converting the pixel value into the conversion pixel values in FIGS. 7A to 7D and generating conversion information having a unique correspondence relationship so as to be consistent with the data distribution characteristic of the haptic signal values.

By the above-described processing, that is, not encoding the haptic signal value as it is but encoding the difference from the value after pixel value conversion corresponding to the pixel value in the same space, that is, the predicted haptic value (conversion pixel value), it is possible to increase the compression efficiency.

Here, returning to the description of the flowchart of FIG. 3 again, in S307, the compression encoding unit 208 performs compression encoding with the difference value calculated in S306 as an input, and outputs haptic encoded data of one picture.

In S308, the image encoded data already encoded in S300 and the haptic encoded data compressed and encoded in S307 are read from the work memory 106 in units that are easily subjected to synchronization processing by, for example, a decoder described later, by, for example, one picture, and multiplexing is performed as one bit stream.

In addition, the pixel value conversion information generated in S303 is similarly read from the work memory 106 and multiplexed as header data at a position of a bit stream corresponding to a sequence head described later.

After this step is executed, the process returns to S304 again, and is repeated until the compression encoding of the haptic information is completed for all the pictures in the sequence.

On the other hand, in S309 to which it is determined in S302 that there is no correlation between the image information and the haptic information and transition is made, it is determined whether the processing has been performed up to the final picture. In the case of NO, the process transitions to S310, and the processes in and after S310 are performed on the next picture. In the case of YES, it can be determined that the encoding of the haptic information has been completed for all the pictures in the sequence, and thus the present flow ends.

In S310, since there is no correlation between the pixel information and the haptic information, the above-described pixel value conversion information is not used, the data path of the selector 212 is switched, and the haptic information is directly compressed and encoded (directly encoded).

Then, in S311, similarly to S308, processing is performed in which the image encoded data already encoded in S300 and the haptic encoded data compressed and encoded in S307 are read from the work memory 106 and multiplexed as one bit stream.

After this step is executed, the process returns to S309 again, and is repeated until the compression encoding of the haptic information is completed for all the pictures in the sequence.

The above is the processing flow executed by the information compression encoding unit 103 of the present embodiment.

### Processing Content of Multiplexing Unit 209

Next, the processing content and data format necessary for decoding and decompressing the haptic encoded data multiplexed in the above-described S308 and S311 to the original haptic information at a decoder outside the apparatus will be described.

This processing is executed mainly by the multiplexing unit 209 and the header generation unit 210 inside thereof.

As described above as the functions of the image encoding unit 201 and the compression encoding unit 208, the present embodiment assumes the compression technology standardized by the international standard according to H. 264 or HEVC. Therefore, the syntax structure and semantic of the bit stream also follow and extend the above standard. The same applies to the header information.

However, the present invention is not limited only to the data structure described in the present embodiment, and may have the identification information and data having same meaning, and the decoding apparatus having received the compressed data may be correctly decodable of the haptic information.

The present embodiment adopts a bit stream structure defined by the HEVC standard. Then, the image encoded data and the haptic encoded data are encapsulated in units of bytes by a network abstraction layer (hereinafter called “NAL”) unit, and packetized or byte-streamed according to the application. In this case, the multiplexing unit 209 generates the image encoded data, the haptic encoded data, and the pixel value conversion information as respective different NAL units.

The image encoded data is configured as a video coding layer (hereinafter called “VCL”). Then, the haptic encoded data and the pixel value conversion information are configured using supplemental enhancement information (SEI), which is one of NonVCL and can be uniquely defined by the user.

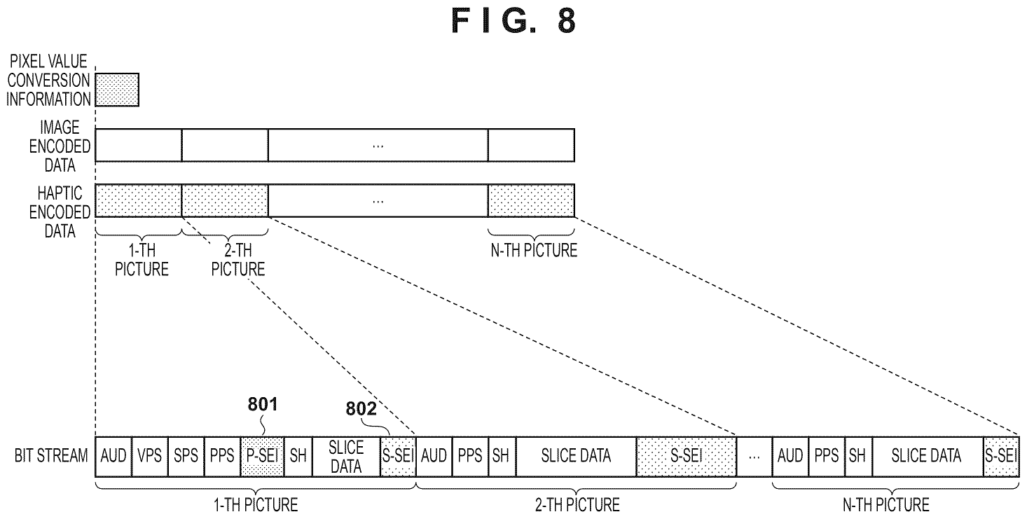

FIG. 8 is a view illustrating a bit stream structure in the present embodiment.

In FIG. 8, an access unit delimiter (AUD), a video parameter set (VPS), a sequence parameter set (SPS), a picture parameter set (PPS), a slice header (SH), and the like are header parameter information necessary for decoding processing of image encoded data defined as a standard, and are generated in a transmission order and format conforming to the standard. Detailed content of the header parameters will not be described.

Then, the SEI storing the above-described pixel value conversion information is arranged prior to the access unit at the sequence head, that is, the first image encoded data and the haptic encoded data.

Thereafter, in the present embodiment, the VCL of the image encoded data encoded in units of synchronized pictures and the SEI of the NonVCL storing the haptic encoded data are multiplexed and output so as to be alternately output in time order.

### Pixel Value Conversion Information SEI Format

Here, the SEI data format for storing the pixel value conversion information will be described. This SEI is arranged before slice data corresponding to the image encoded data of the sequence head as prefix SEI (P-SEI) indicated by 801 in FIG. 8.

This P-SEI storing the pixel value conversion information is created as SEI_message of user_data_unregistered in which a payloadType value that can be uniquely defined by the user is 5 in order to be distinguished from other SEIs. Furthermore, in a user_data_payload_byte field in this message, the above-described pixel value conversion information and related information are stored together.

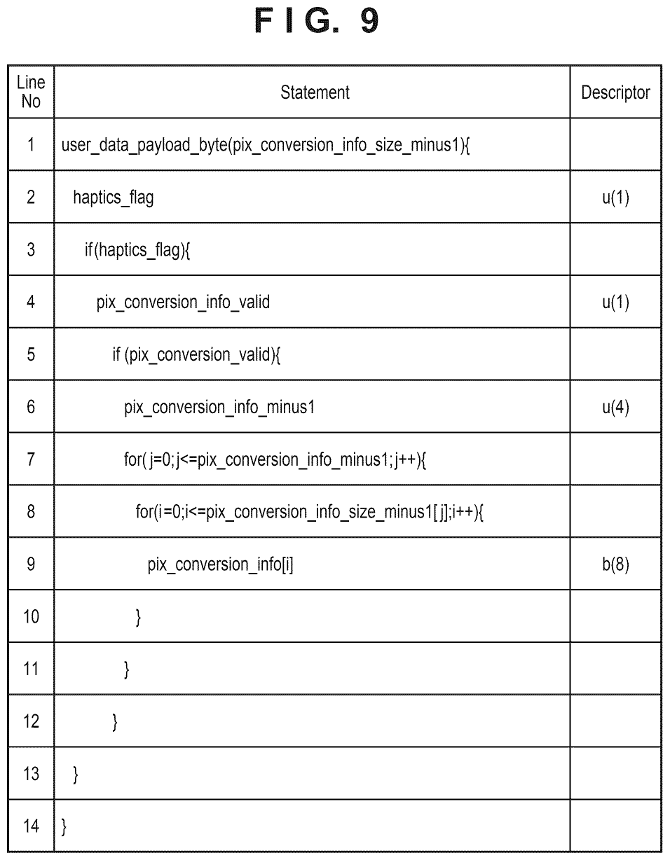

Hereinafter, the data format will be described based on the syntax of the pseudo C program same as the HEVC standard with reference to FIG. 9.

The line number is described in the first column, the statement, in which branches, repetition operations, and variables are defined, is described in the second column, and the descriptor representing the units and formats of variable symbols of the lines is described in the third column.

The input argument pix_conversion_info_size_minus1 is the number of bytes of the pixel value conversion information−1. This corresponds to a difference in which 16 bytes of the uuid_iso_iec_11578 field are subtracted from payloadSize of sei_message ( ), which is an upper layer. This value is generated by the header generation unit 210.

haptics_flag in the second line is a flag indicating the existence or absence of haptic information. In the present embodiment, 1 is set. A case of 0 indicates that there is no haptic information, and indicates that encoding of only a known image is performed.

pixel_conversion_info_valid in the fourth line indicates the existence or absence of the pixel value conversion information. In the present embodiment, the setting value is determined depending on existence or absence of a correlation between the pixel value and the haptic signal value, and 1 is set when there is a correlation, and 0 is set when there is no correlation.

pixel_conversion_info_minus1 in the sixth line indicates the number of types of pixel value conversion information−1. In the present embodiment, 0 is set.

pix_conversion_info in the ninth line indicates the pixel value conversion information itself in byte units.

The above is the data format of the user_data_payload_byte field of the P-SEI storing the pixel value conversion information in the present embodiment.

### Haptic Encoded Data SEI Format

Here, the data format of SEI storing haptic encoded data will be described. This SEI is arranged after the haptic encoded data for one picture as SuffixSEI (S-SEI) indicated by 802 in FIG. 8.

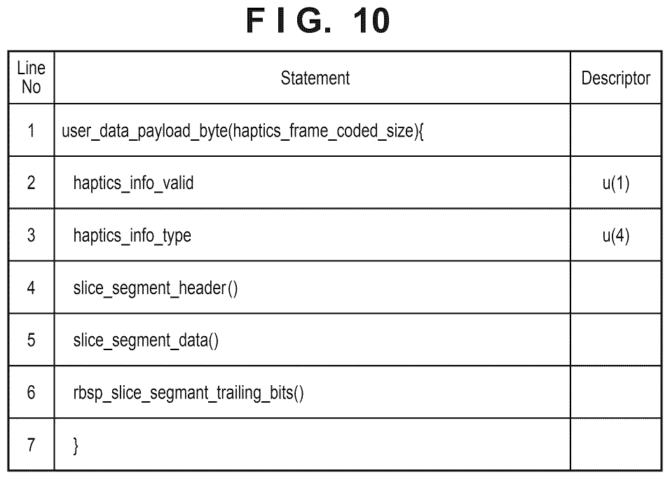

FIG. 10 illustrates the format of haptic encoded data for one picture. This haptic encoded data is packaged in an upper layer of the NAL unit as SEI_message of user_data_unregistered similarly to the P-SEI storing the pixel value conversion information described above.

The input argument haptics_frame_code_size is the number of bytes of the haptic encoded data−1. This corresponds to a difference in which 16 bytes of the uuid_iso_iec_11578 field are subtracted from payloadSize of sei_message ( ), which is an upper layer. This value is generated by the header generation unit 210.

haptics_info_valid in the second line is a flag indicating the existence or absence of use of the pixel value conversion information. When the haptic encoded data to be transferred uses the pixel value conversion information, 1 is set, and when not used, 0 is set.

haptics_info_type in the third line is information for specifying the type of the pixel value conversion information previously sent in P-SEI. In the present embodiment, since there is only one type of pixel value conversion information, this information is ignored.

As described above, since the haptic encoded data of the present embodiment is applied with basically the same compression encoding method as that of the image information, it is assumed that the haptic encoded data can be stored as those generated in the order of slice_segment_header ( ), slice_segment_data ( ), and rbsp_slice_segment_trailing_bits ( ) determined by the standard illustrated in the drawing.

The above is the data format when the haptic encoded data in the present embodiment is stored in the user_data_payload_byte field of the S-SEI.

In the present embodiment, the P-SEI storing the pixel value conversion information is inserted only into the first picture, and the pixel value conversion information transferred there is applied to the entire sequence. On the other hand, the S-SEI storing the haptic encoded data is inserted for each picture.

The above is the bit stream structure and the data format in the case of multiplexing the haptic encoded data and the pixel value conversion information in the present embodiment.

As described above, according to the present embodiment, it is possible to efficiently encode haptic information by encoding the haptic information using the correlation with the image information.

### Second Embodiment

In the first embodiment described above, the method of obtaining the pixel value converted data on the assumption that the haptic signal value corresponding to the pixel value through the entire sequence has a one-to-one correspondence relationship has been described.

In the second embodiment, a generation method of pixel value conversion information when a plurality of haptic signal values paired with pixel values exist will be described. Note that in the description of the second embodiment, parts common to those of the first embodiment described above are given the same reference numerals, and the description thereof will be appropriately omitted.

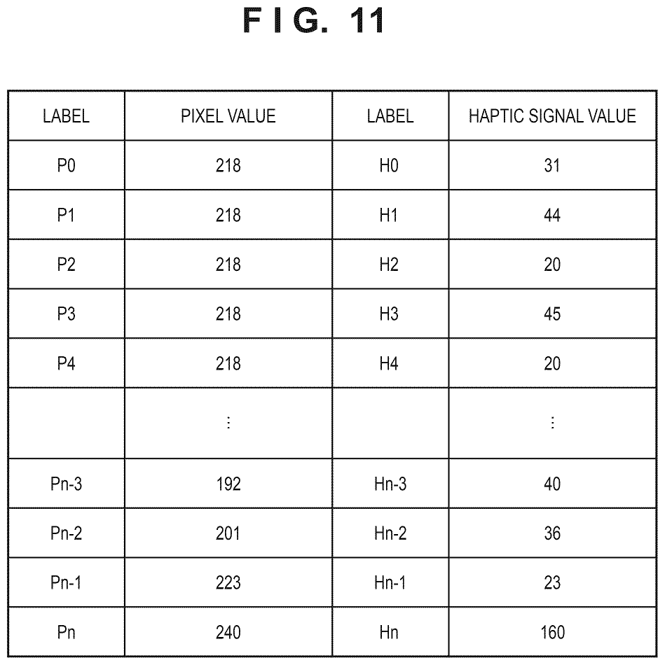

FIG. 11 is a view showing an example of pixel values and haptic signal values acquired through the entire sequence in the present embodiment, similarly to FIG. 5 of the first embodiment.

As shown in FIG. 11, it is assumed that, depending on an object of a haptic target that is a target, a plurality of pixel values 218 exist in a two-dimensional space, and haptic signal values corresponding to the respective pixel values have different values such as 31, 44, 20, 45, and 20.

Even in such a case, in order to achieve the efficiency of compression of haptic information using the correlation with the pixel information described above, in the present embodiment, the pixel value conversion information is generated using representative values such as the mean value, the median value, and the mode value of the haptic signal values having the same pixel value.

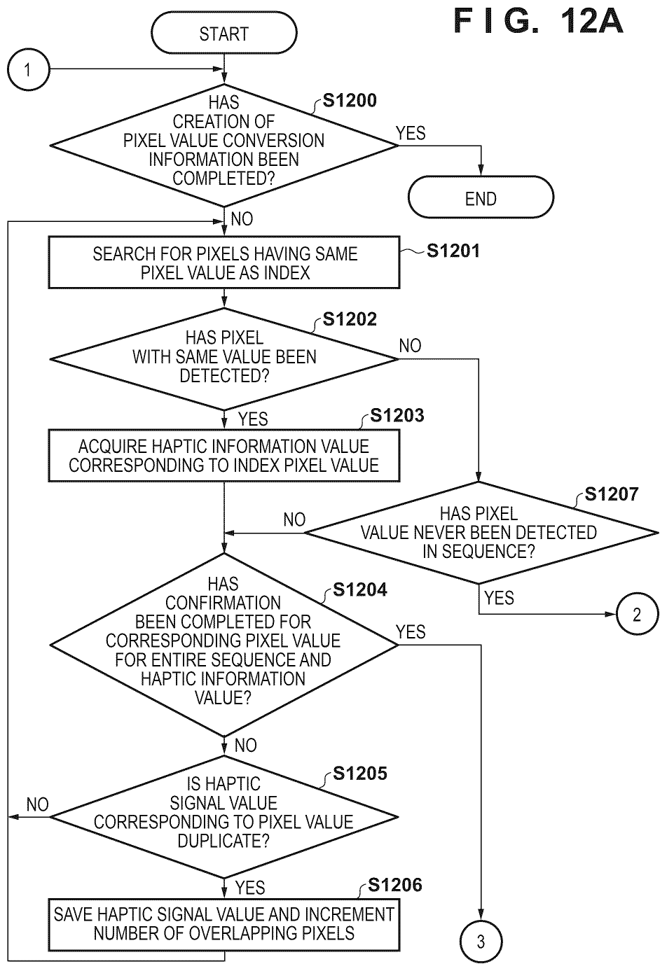

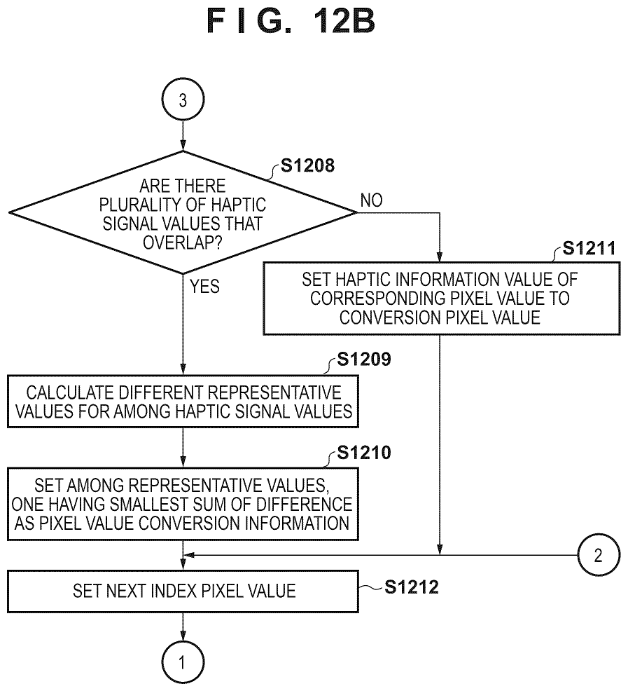

Operation Flow FIGS. 12A and 12B are flowcharts showing the operation of the pixel value conversion information generation unit 204, which is a characteristic operation of the present embodiment. The operation of this flowchart is started from the timing when the recording of the image information and the haptic information of the entire sequence into the work memory 106 or the recording unit 104 is completed, similarly to the first embodiment.

In S1200, it is determined whether the pixel value conversion information has been created for all the ranges of the pixel values. If there is still uncreated pixel value conversion information, the process proceeds to S1201 (NO in S1200). On the other hand, if the creation of the pixel value conversion information has been completed (YES in S1200), the present operation flow ends.

In step S1201, pixels having the same pixel value as the index that is the input value of the above-described pixel value conversion information are sequentially searched from the pixel information recorded as a sequence. The initial value of the index starts with zero as a minimum value, and the maximum value is a value determined by the bit depth of the pixel.

In S1202, it is determined whether or not a pixel having the same pixel value as the above index value has been detected in the sequence. If detected (YES in S1202), a haptic signal value corresponding to the pixel value is acquired and held in S1203. If not found (NO in S1202), the process transitions to the determination step in S1207.

After the execution of S1203, the process proceeds to the determination step of S1204, and it is determined whether or not search and duplication confirmation have been completed for the current pixel value for the entire sequence and the haptic signal value corresponding to the pixel value.

In a case of the middle of the sequence (NO in S1204), the process proceeds to S1205, and the haptic signal value corresponding to the pixel value detected this time is compared with the haptic signal value detected last time, and it is determined whether it is a different value.

On the other hand, if the search has been performed up to the end of the sequence (YES in S1204), the process proceeds to S1208, and the transitions to a series of registration processing to the pixel value conversion information.

If it is determined in the comparison and determination step of S1205 that different haptic signal values are present for the same pixel value (YES in S1205), a haptic signal value is saved and a count value indicating the number of overlapping pixels is incremented in S1206.

After execution of S1206 and if the haptic signal values are the same in S1205 (NO in S1205), the process returns to S1201, and search for a pixel having the same pixel value as the index pixel value is repeated again.

In S1207, to which the process is transitioned from NO in S1202, it is determined whether or not the index pixel value currently being searched has never appeared in the sequence.

If the index pixel value has been detected once or more (NO in S1207), the process proceeds to the determination step in S1204. On the other hand, in the case of a pixel value never appeared in the sequence (YES in S1207), there is no haptic signal value corresponding to the index value. Therefore, a predetermined invalid value not illustrated is registered in the pixel value conversion information, and the process proceeds as it is to the setting of the next index pixel value in S1212.

S1208 is a determination step for when the process arrives as a result of the search regarding the currently searched index value for up to the end of the sequence, and here, it is determined whether or not the pixel corresponding to the index value has a plurality of haptic signal values.

If one pixel value has a plurality of haptic values through the sequence (YES in S1208), the process proceeds to S1209, and a plurality of different representative values are calculated for the plurality of haptic signal values that are stored and held. The present embodiment assumes that three types of arithmetic mean, mode value, and median value are derived as representative values thereof.

Furthermore, in subsequent step S1210, among the representative values, one having the smallest sum of the difference absolute values from each haptic signal value is calculated, and the representative value is registered as the pixel value conversion information.

On the other hand, if no overlapping haptic signal value exists (NO in S1208), as in the first embodiment described above, the haptic signal value corresponding to the pixel value is registered in the pixel value conversion information as pixel value converted data.

After the execution of S1210 and S1211, the process proceeds to S1212, the index pixel value to be searched next is set, and a series of operations starting from S1200 is repeated.

The above is the operation flow of the present embodiment.

Here, regarding a determination method of pixel value converted data performed in S1209 and S1210, which is a feature of the present embodiment, an example in which the pixel values 218 indicated by the labels P0 to P4 in FIG. 11 overlap in the haptic signal values 31, 44, 20, 45, and 20 will be described.

In the example of FIG. 11, for the index pixel value 218, already stored haptic signal values for 5 pixels of 31, 44, 20, 45, and 20 exist. Then, regarding the haptic signal values for the overlapping 5 pixels, the mean value is 32, the median value is 31, and the mode value is 20.

For these three representative values, a cumulative total of difference absolute values from each haptic signal value is calculated. Although the details of the calculation process are omitted, in the case of the present embodiment, as a result, the cumulative total of difference absolute values from the mean value is 50, the cumulative total of difference absolute values from the median value is 49, and the cumulative total of difference absolute values from the mode value is 60.

As described above, the cumulative total of the difference absolute values is minimum at the median value, and 31, which is the median value, is determined as the pixel value converted data.

In this manner, according to the second embodiment, even when a plurality of haptic signal values paired with pixel values exist, it is possible to determine optimum pixel value converted data and generate pixel value conversion information.

### Third Embodiment

In the first and second embodiments described above, the compression encoding method has been described assuming a case where there is only one subject object of a compression encoding target during a sequence from photography start to stop.

Next, as the third embodiment, a data generation method when a plurality of subject objects exist or when an object having a different haptic sensation appears in the same picture will be described. Note that in the description of the third embodiment, parts common to those of the first and second embodiments described above are given the same reference numerals, and the description thereof will be appropriately omitted.

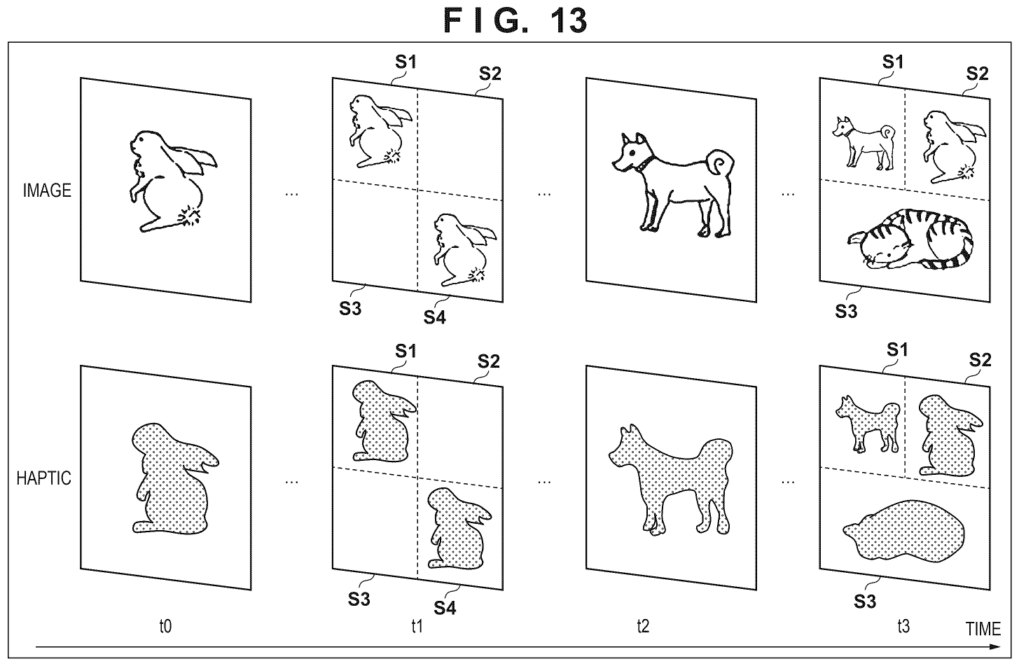

FIG. 13 is a conceptual diagram illustrating a case where an image handled in the present embodiment and an encoding target as haptic information change over time in the middle of a sequence. Note that a time direction is indicated by an arrow from left to right in the lower part of the drawing.

As illustrated in FIG. 13, in the present embodiment, the following case will be described. First, starting from time to, the encoding target is changed from one encoded object (one rabbit) to two encoded objects (two rabbits) having the same haptic sensation at timing of time t1. Thereafter, at time t2, they are changed to one encoded object (one dog) having different haptic sensation. Finally, it is changed into three encoded objects (dog, rabbit, and cat) having different haptic sensations.

In the first embodiment described above, the pixel value conversion information is created and transmitted only once at the sequence head, and then the image encoded data and the haptic encoded data synchronized in units of pictures are transmitted.

In the present embodiment, if a plurality of encoding target objects exist in the same screen as times t1 and t3, the concept of tile division defined in the HEVC standard is adopted. Specifically, one picture is divided as a two-dimensional partial area for each rectangular area including a haptic encoding target object, and is treated as a format that can be compressed and encoded and decoded independently. Then, whether to generate and output S-SEI that is haptic encoded data is switched for each tile.

When the encoding target object changes to an encoding target object having different haptic sensation in the middle of the sequence at time t2, the change is detected, the pixel value conversion information is generated again (regenerated), and the P-SEI is retransmitted in the middle of the stream. As a detection method of a change of an object, for example, a method of creating and using a model in which an image and a label of an object are learned by a deep learning technology for a plurality of objects in advance, which is a known technology, may be used. Using the created model, an object may be inferred from target image information to detect a change. The area of tile division may be determined depending on the state of change.

Furthermore, when a plurality of objects having different haptic sensations simultaneously appear as at time t3, P-SEI for transmitting a plurality of pieces of pixel value conversion information is defined, and association with haptic encoded data (S-SEI) is performed with reference to different pieces of pixel value conversion information for each tile.

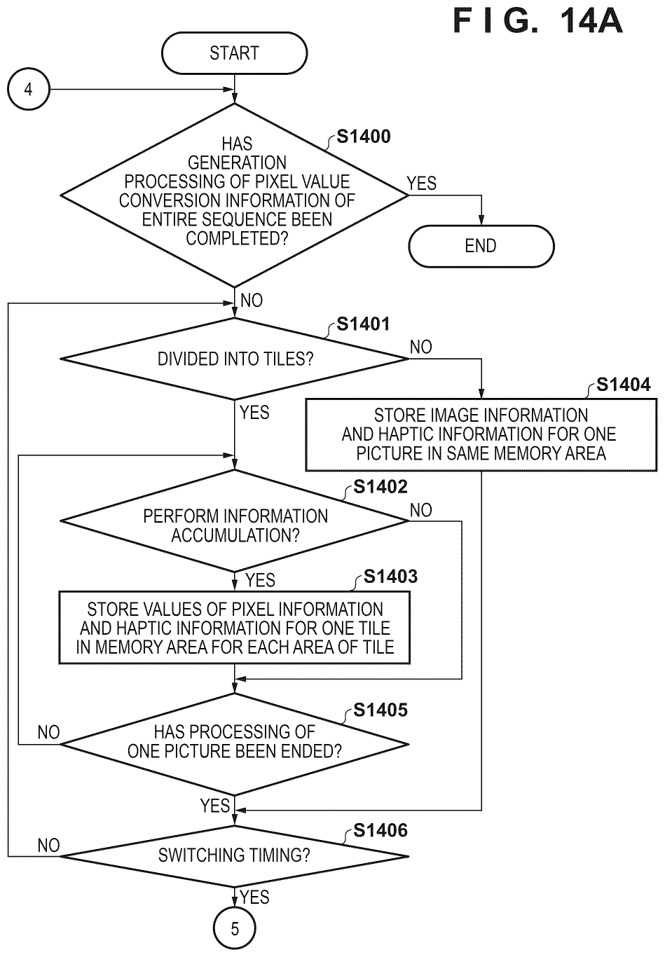

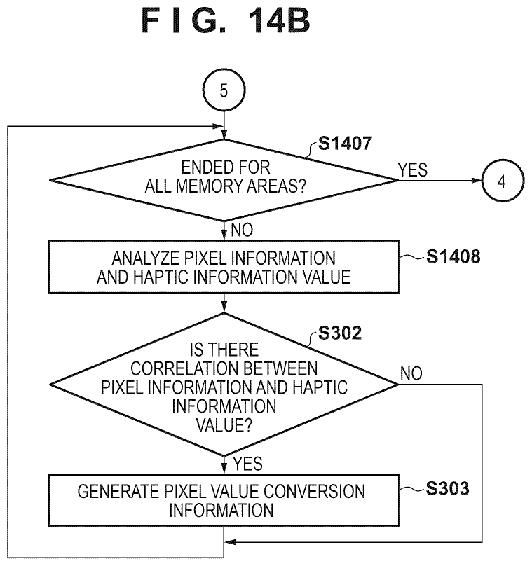

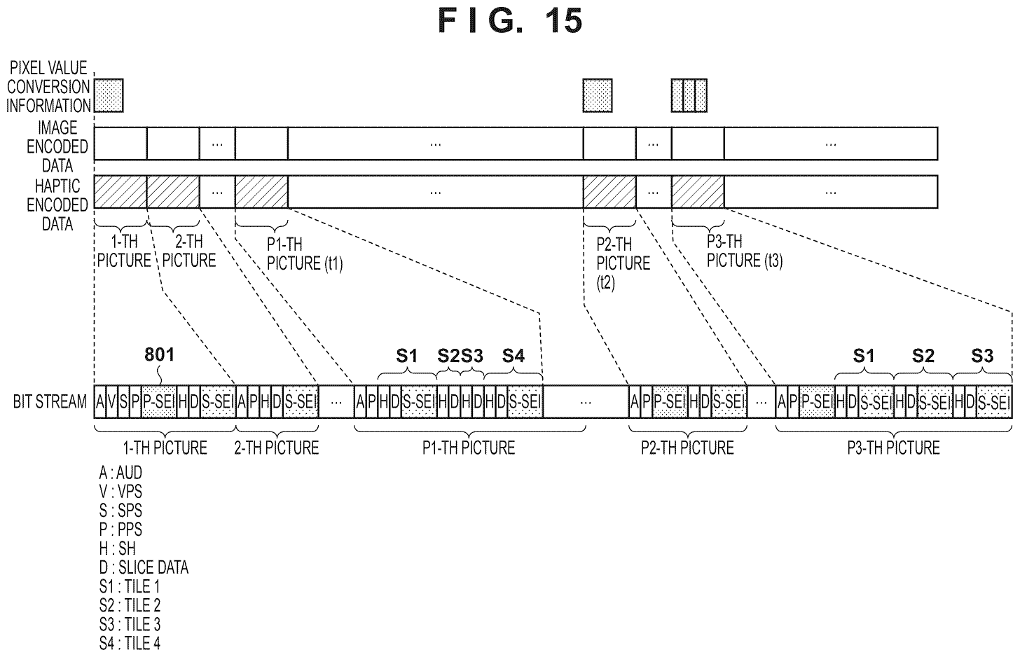

Hereinafter, the operation until the pixel value conversion information, which is a feature of the present embodiment described above, is generated will be described with reference to the flowcharts of FIGS. 14A and 14B. The operation of the multiplexing of haptic encoded data will be described with reference to FIG. 15.

### Operation Flow

FIGS. 14A and 14B are flowcharts showing the operation until the pixel value conversion information is generated. Similarly to the start timing of the flowchart of FIG. 3, this flowchart is started at the timing when all the pieces of data of the image information and the haptic information constituting a sequence are aligned in the work memory 106.

First, in S1400, it is confirmed whether or not the generation processing of the pixel value conversion information of the entire sequence has been completed. If the processing is ended (YES in S1400), the present flowchart is ended. If the process is not completed (NO in S1400), the process proceeds to S1401.

In S1401, image information and haptic information for one picture are read, and it is determined whether or not the picture is divided into tiles. When divided into tiles (YES in S1401), the process proceeds to S1402. When not divided into tiles (NO in S1401), the process proceeds to S1404.

In S1402, it is determined whether or not to perform information accumulation processing for generating pixel value conversion information.

In the tile division defined in the HEVC standard, tile identifiers are allocated in raster scan order from 1. For example, in the image at time t1 in FIG. 13, one picture is divided into four, an object of a rabbit exists in tile 1 and tile 4, and no object exists in tile 2 and tile 3. The information accumulation processing is skipped for the tiles in which no object exists in this manner.

The information accumulation processing is skipped also when there is an object having the same haptic sensation in the information accumulated so far. For example, in the processing of the image at time t1 in FIG. 13, when tile 4 is executed, since the object has the same haptic sense as the tile 1, this branch transitions to NO.

If the information is accumulated in S1402 (YES in S1402), the process proceeds to S1403. If the information is not accumulated (NO in S1402), the process proceeds to S1405.

In S1403, the values of the pixel information and the haptic information for one tile are temporarily stored in a memory inside the analysis unit 203 not illustrated. At this time, a memory area is secured for each area of the tile, and information is accumulated in the same memory area for the same tile area.

In S1404, the image information and the haptic information for one picture are stored in one memory area of the memory inside the analysis unit 203 not illustrated.

In S1405, it is confirmed whether or not the processing of one picture has been ended. When all the values of the pixel information and the haptic information for the tile division have been stored in the memory (YES in S1405), the process proceeds to S1406. If the processing of one picture is not finished (NO in S1405), the process returns to S1402 again.

In S1406, it is confirmed whether or not the switching timing has occurred.

As described with reference to FIG. 13, the switching timing occurs when an object having a different haptic sensation occurs. For example, in FIG. 13, it occurs at times t2 and t3. Since the object is an object having the same haptic sensation as time to, switching does not occur at time t1.

Here, it is a known technique that the image information encoding unit 201 can recognize the switching timing of the haptic target, and the analysis unit 203 is notified of the timing.

If the switching occurs in S1406 (YES in S1406), the process proceeds to S1407. If the switching does not occur (NO in S1406), the process returns to S1401, accumulation of data of the next picture is continued.

In S1407, it is determined whether or not the analysis of all the data accumulated so far has been ended. If the analysis has been all completed (YES in S1406), the process returns to S1400, and the data of the picture after the switching timing is accumulated from the beginning. If the analysis has not been completed (NO in S1407), the process proceeds to S1408.

In S1408, the analysis performed by the analysis unit 203 is performed, and the process proceeds to S302. S302 and S303 are as described above.

The pixel value conversion information generated in S303 is stored in the memory 205.

The generation method of pixel value conversion information when there is a temporal change in a haptic object has been described above with reference to FIGS. 14A and 14B.

### Stream Structure

Next, FIG. 15 is a view illustrating a bit stream structure output based on the above-described operation flow when there is a temporal change in the haptic object as in FIG. 13 described above.

Note that the alphabets added in the square area corresponding to a NAL unit in the bit stream in the drawing are abbreviations of the NAL unit types. A represents AccessUnitDelimiter, V represents VideoParameterSet, S represents SequenceParameterSet, P represents PictureParameterSet, H represents Slice Header, and D represents SliceData.

First, the data structure and arrangement of various NAL units corresponding to the first picture of the bit stream illustrated in FIG. 15 correspond to data generated and encoded at the timing of time t0 in FIG. 13.

The pixel value conversion information is conversion information for rabbits, and the pixel value conversion information is embedded in the P-SEI of the bit stream and output. At and after the second picture, the pixel value conversion information sent to the first picture is handed over and decoded, and therefore P-SEI is not sent.

The P1-th picture corresponds to time t1 in FIG. 13. At time t1, although the number of rabbits increases from one to two, the pixel value conversion information itself is not switched because of the object having the same haptic sense. Therefore, the P-SEI is not transmitted.

Since the P1 picture is divided into four tiles, the S-SEI is transmitted for each tile. In the P1 picture, objects exist in tile 1 and tile 4, but no objects exist in tiles 2 and 3, and thus the S-SEI of tiles 2 and 3 is not transferred.

The P2-th picture corresponds to time t2 in FIG. 13. At time t2, the two rabbits are changed to one dog, and the object has a different haptic sensation. Therefore, the pixel value conversion information is conversion information for dogs, and the pixel value conversion information is embedded again in the P-SEI of the bit stream and output.

The P3-th picture corresponds to time t3 in FIG. 13. At time t3, the picture is switched from a picture of one dog to a picture having a plurality of objects having different haptic sensations such as a dog, a rabbit, and a cat. Therefore, three types of pixel value conversion information of the dog, the rabbit, and the cat are transmitted to the P-SEI.

Since the dog is transferred at the P2-th picture, the dog can be performed even without being sent. However, in the present embodiment, in order to simplify the processing, after the switching timing, the P-SEI of the previous picture is not used, and the pixel value conversion information necessary for decoding the corresponding picture is sent again.

A value of the user_data_payload_byte field stored in the P-SEI illustrated in FIG. 9 when the P3-th picture in FIG. 15 is executed will be described.

Since haptics_flag in the second line of FIG. 9 is a flag indicating the existence or absence of haptic information, 1 is set.

Since pixel_conversion_info_valid in the fourth line indicates the existence or absence of the pixel value conversion information, 1 is set.

Since pixel_conversion_info_minus1 in the sixth line indicates the number of types of pixel value conversion information−1, and thus it is 2 in the present embodiment.

pix_conversion_info in the ninth line indicates the pixel value conversion information itself in byte units.

In pic_conversion_info_size_minus1, the number of byte sizes of the pixel value conversion information−1 is stored. This value is an array, and is associated with the following in the present embodiment.
pic_conversion_info_size_minus1 [0]=byte size of pixel value conversion information of dog−1
pic_conversion_info_size_minus1 [1]=byte size of pixel value conversion information of rabbit−1
pic_conversion_info_size_minus1 [2]=byte size of pixel value conversion information of cat−1

Subscripts 0 to 2 of the array of this case correspond to haptics_info_type of the user_data_payload_byte field of the S-SEI as the identification signal of the pixel value conversion information. 0 represents the pixel value conversion information of the dog, 1 represents the pixel value conversion information of the rabbit, and 2 represents the pixel value conversion information of the cat.

The operation of the multiplexing of haptic encoded data in the present embodiment has been described above with reference to FIG. 15.

Thus, according to the third embodiment, even when there is a temporal change in a haptic object, the pixel conversion information for each tile or each picture can be created, and the corresponding pixel conversion information can be included in the bit stream and transferred to the decoding apparatus.

### Fourth Embodiment

In the first to third embodiments described above, the compression encoding method and apparatus of haptic information using image information have been described.

In the fourth embodiment, a method of receiving compressed and encoded data generated in the information compression apparatuses of the first to third embodiments and decoding and decompressing the compressed and encoded data into original image information and haptic information will be described.

Note that in the description of the fourth embodiment, parts common to those of the first to third embodiments described above are given the same reference numerals, and the description thereof will be appropriately omitted.

### System Configuration

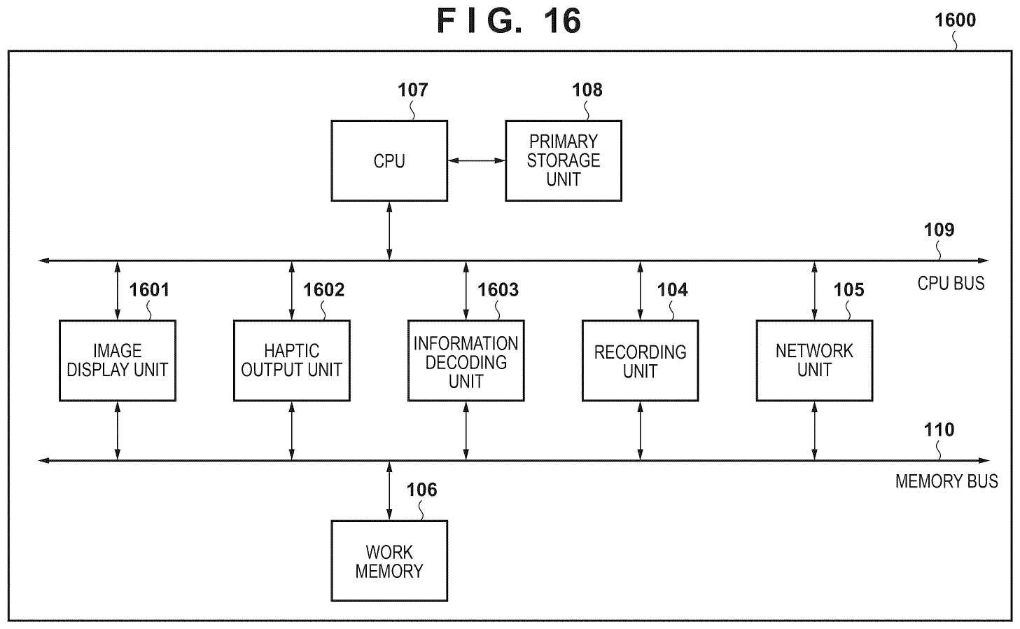

FIG. 16 is a block diagram illustrating a system configuration example of the information decoding apparatus 1600 in the present embodiment.

The system of the present embodiment is configured to include an image display unit 1601, a haptic output unit 1602, an information decoding unit 1603, the recording unit 104, the network unit 105, the work memory 106, the CPU 107, the primary storage unit 108, the CPU bus 109, and the memory bus 110.

Since the recording unit 104, the work memory 106, the CPU 107, the primary storage unit 108, the CPU bus 109, and the memory bus 110 have the same functions as those described in the first embodiment, the description thereof will be omitted.

The image display unit 1601 is a display apparatus such as a monitor or a head-mounted display, reads, from the work memory, image information decoded by the information decoding unit 1603, and displays an image.

The haptic output unit 1602 is a device configured to present haptic information to a human body, such as a haptics suit or a haptics glove, reads, from the work memory, the haptic information decoded by the information decoding unit 1603, and reproduces the haptic information.

The network unit 105 is an interface for connecting the information decoding apparatus 1600 and an external apparatus, and, in the present embodiment, communicates with the external apparatus via the network, receives a bit stream, and stores the bit stream into the work memory 106. Details of the information decoding unit 1603 will be described later.

### Internal Configuration of Information Decoding Unit 1603

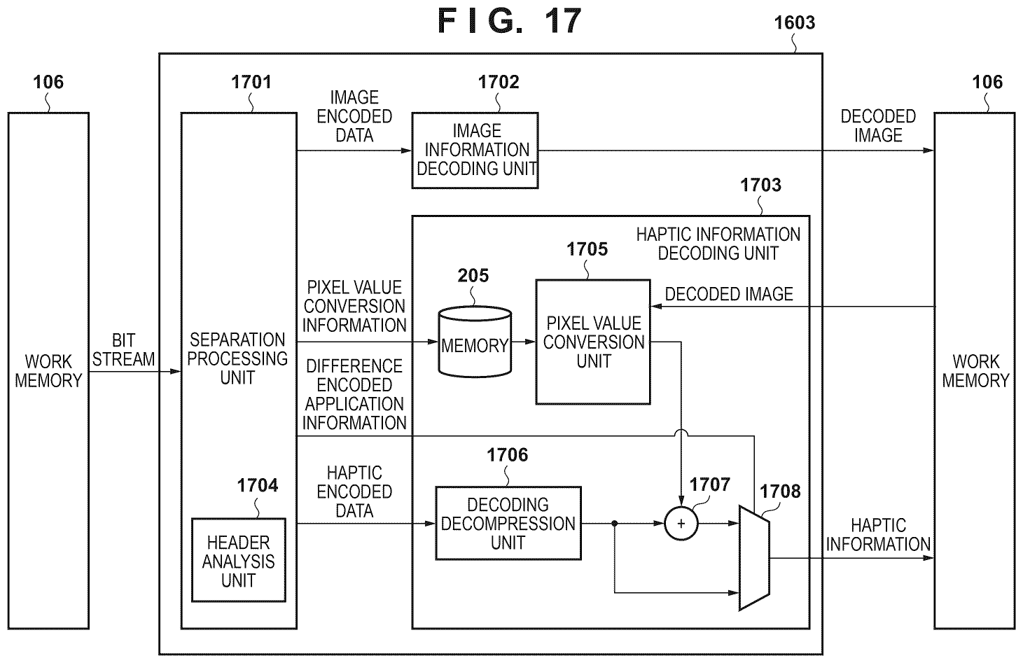

FIG. 17 is a block diagram illustrating the configuration of the information decoding unit 1603 in the present embodiment. The information decoding unit 1603 is configured to include a separation processing unit 1701, an image information decoding unit 1702, and a haptic information decoding unit 1703.

The haptic information decoding unit 1703 is configured to include the memory 205, a pixel value conversion unit 1705, a decoding decompression unit 1706, an addition unit 1707, and a selector 1708.

The separation processing unit 1701 includes a header analysis unit 1704 and analyzes the header of a bit stream. The bit stream is read from the work memory 106, and haptics_flag, pix_conversion_info_valid, pix_conversion_info_size_minus1, and pix_conversion_info_minus1 included in P_SEI in the bit stream are acquired. haptics_info_valid and haptics_info_type included in S_SEI in the bit stream are acquired. The meaning of each data is as described above.

When pix_conversion_info_valid is 1, the pixel value conversion information is acquired from pix_conversion_info and written into the memory 205. The pixel value conversion unit 1705 and the selector 1708 are notified of haptics_info_valid. Then, the pixel value conversion unit 1705 is notified of haptics_info_type.

Furthermore, the image encoded data acquired from the slice data in the bit stream is transferred to the image information decoding unit 1702, and the haptic encoded data acquired from the S-SEI is transferred to the haptic information decoding unit 1703.

The image information decoding unit 1702 decodes the image encoded data input from the separation processing unit 1701. The decoded image information is written into the work memory 106.

The pixel value conversion unit 1705 reads the pixel value conversion information from the memory 205. A decoded image is read from the work memory 106, the pixel value of the decoded image is applied with the pixel value conversion information, and the pixel value converted data is generated and output to the addition unit 1707.

If there are a plurality of types of pixel value conversion information, it is determined which pixel value conversion information to use by using haptics_info_type notified from the separation processing unit. Then, the pixel conversion information is read from the memory area in which the corresponding information is stored in the memory 205.

The decoding decompression unit 1706 inputs haptic encoded data and outputs a decoding result. The decoding result is a difference value between the haptic information and the pixel value converted data when the image conversion information is used, and is the haptic information itself when the image conversion information is not used.

The addition unit 1707 adds up the difference value output by the decoding decompression unit 1706 and the pixel value converted data output by the pixel value conversion unit.

The selector 1708 uses, as a selection control signal, haptics_info_valid from the separation processing unit, and if this signal is 1, the output result of the addition unit is set as the haptic information, and if the signal is 0, the output of the decoding decompression unit 1706 is set as the haptic information. The haptic information is written into the work memory 106.

As described above, the haptic information can be decoded by the haptic information decoding unit 1703 and written into the work memory 106. The image information and the haptic information written in the work memory 106 are read by the image display unit 1601 and the haptic output unit 1602 and reproduced.

### Operation Flow of Information Decoding Unit

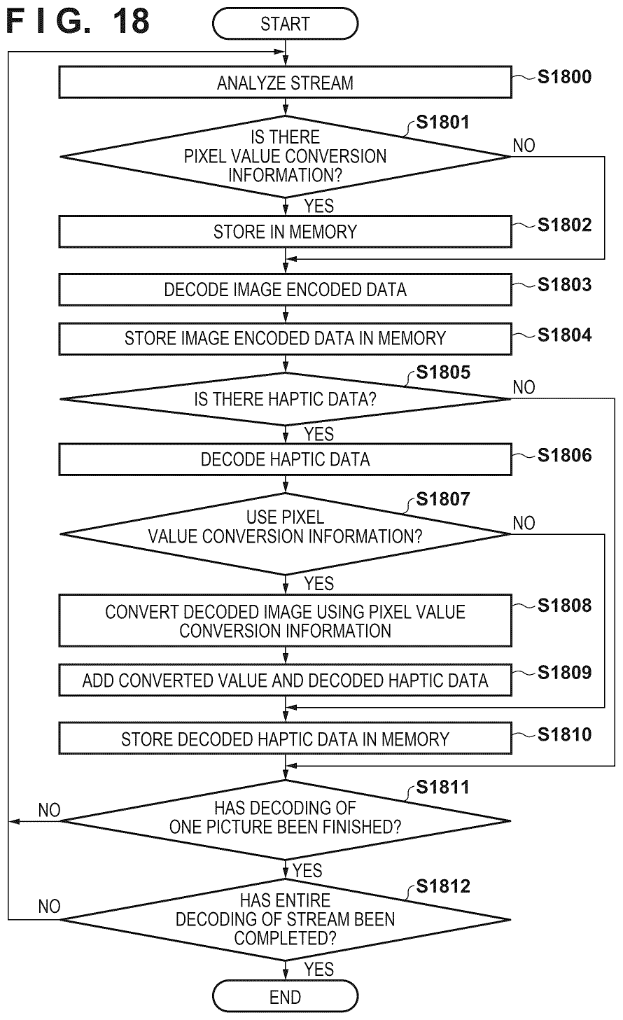

Next, FIG. 18 is a flowchart showing the operation of the information decoding unit 1603. It is assumed that this operation flow is started from the timing when the bit stream arrives at the information decoding unit 1603.

In S1800, the separation processing unit 1701 analyzes the bit stream and separates the bit stream into image encoded data, haptic encoded data, and pixel value conversion information. The haptic encoded data and the pixel value conversion information are not always included in the bit stream.

The existence or absence of the haptic information in the entire sequence can be determined by haptics_flag of user_data_payload_byte of the P-SEI. Whether or not the pixel value conversion information is used can be determined by pix_conversion_info_valid. Whether or not the haptic encoded data exists in units of tiles can be determined by the existence or absence of S-SEI. The result determined here is used in the determination processing in S1801, S1805, and S1807, which are steps at the subsequent stage.

In S1801, the existence or absence of the pixel value conversion information is determined. Here, if the value of pix_conversion_info_valid of P-SEI is 1, it is determined that there is the pixel value conversion information (YES in S1801), and the process proceeds to S1802. If not (NO in S1801), the process proceeds to S1803.

In S1802, pix_conversion_info stored in the P-SEI is extracted and stored in the memory 205.

In S1803, the image information decoding unit 1702 receives the image encoded data from the separation processing unit 1701 and performs decoding.

In S1804, the decoded image is written into the work memory 106.

In S1805, the existence or absence of haptic data is determined. This determination uses the determination described in S1800. If there is no haptic data (NO in S1805), the process transitions to S1811. If there is haptic data (YES in S1805), the process transitions to S1806.

In S1806, the haptic encoded data separated by the separation processing unit 1701 is decoded.

In S1807, it is determined whether or not the pixel value conversion information is used. This determination is performed using haptics_info_valid stored in user_data_payload_byte of the S-SEI acquired from a stream by the separation processing unit 1701. If haptics_info_valid is 1 (YES in S1807), the process transitions to S1808, and if it is 0 (NO in S1807), the process transitions to S1810.

In step S1808, the pixel value conversion unit 1705 reads the pixel value conversion information from the memory 205. Here, if there is a plurality of pieces of pixel value conversion information in the memory 205, it is uniquely determined which pixel value conversion information to read with haptics_info_type stored in user_data_payload_byte of the S-SEI. Then, a decoded image corresponding to the haptic information that is a current decoding target is read from the work memory 106. Using this decoded image and the pixel value conversion information, pixel value converted data is generated.

In S1809, the pixel value converted data generated in S1808 and the decoded haptic data are added.

In S1810, the haptic information is written into the work memory 106.

In S1811, it is determined whether or not decoding of one picture has been finished, and if decoding has been finished (YES in S1811), the process proceeds to S1812. If decoding has not yet been performed (NO in S1811), the process returns to S1800.

In S1812, it is determined whether or not entire decoding of the stream has been completed, and if decoding has not been completed (NO in S1812), the process returns to S1800 again, and processing of the next picture is performed. If completed (YES in S1812), the present flow is ended.

As described above, according to the present embodiment, the bit stream generated by the information compression apparatus 100 can be decoded by the information decoding apparatus 1600.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-045343, filed Mar. 21, 2024, which is hereby incorporated by reference herein in its entirety.

What is claimed is:

1. An information encoding apparatus configured to encode image information and haptic information, the information encoding apparatus comprising:
at least one processor or circuit and a memory storing instructions to cause the at least one processor or circuit to perform operations of the following units:
a first encoding unit configured to encode the image information;
a second encoding unit configured to encode the haptic information, the second encoding unit including
an analysis unit configured to analyze a correlation between the image information not encoded and the haptic information not encoded,
a generation unit configured to generate pixel value conversion information that is information for converting a pixel value in the image information not encoded into a conversion pixel value that is a different pixel value based on an analysis result by the analysis unit,
a calculation unit configured to calculate a difference value between a haptic signal value in haptic information and the conversion pixel value corresponding to a same spatial position as the haptic signal value, and
an encoding unit configured to encode the difference value; and
a multiplexing unit configured to multiplex image encoded data encoded by the first encoding unit, haptic encoded data encoded by the second encoding unit, and the pixel value conversion information into one bit stream.

2. The information encoding apparatus according to claim 1, wherein an original image or a decoded image is input to the analysis unit as the image information.

3. The information encoding apparatus according to claim 1, wherein the generation unit generates the pixel value conversion information such that the difference value becomes a smaller value.

4. The information encoding apparatus according to claim 1, wherein the pixel value conversion information has a data structure of a lookup table that can be obtained with a pixel value in the image information as input and the conversion pixel value as output.

5. The information encoding apparatus according to claim 1, wherein in a case where a plurality of paired haptic signal values exist for one pixel value in the image information not encoded, the generation unit generates the pixel value conversion information so as to convert the one pixel value into a pixel value corresponding to any of a mean value, a median value, and a mode value of the plurality of paired haptic signal values.

6. The information encoding apparatus according to claim 1, wherein the generation unit does not generate the pixel value conversion information when a correlation between the image information not encoded and the haptic information not encoded is lower than a predetermined value.

7. The information encoding apparatus according to claim 6, wherein the second encoding unit directly encodes the haptic information input when the pixel value conversion information is not generated.

8. The information encoding apparatus according to claim 1, wherein the generation unit regenerates the pixel value conversion information at a predetermined timing in a case where the image information and the haptic information temporally change.

9. The information encoding apparatus according to claim 8, wherein the case where the image information and the haptic information temporally change is at least any of a case where a subject included in the image information or the haptic information changes, a case where a number of subjects changes, and a case where brightness of the image information changes.

10. The information encoding apparatus according to claim 1, wherein when the haptic information includes a plurality of subjects, the second encoding unit analyzes image information and haptic information for each area of the subjects, and generates the pixel value conversion information for each area of the subjects.

11. The information encoding apparatus according to claim 1, wherein the multiplexing unit includes a generation unit configured to generate header data in which encoding control information necessary for decoding the image encoded data and the haptic encoded data is described, and outputs the header data prior to the image encoded data and the haptic encoded data.

12. The information encoding apparatus according to claim 11, wherein the multiplexing unit describes, in the header data, at least any of information indicating existence or absence of the pixel value conversion information, information on a number of pieces of the pixel value conversion information, identification information on a plurality of pieces of the pixel value conversion information, and the pixel value conversion information.

13. An information decoding apparatus configured to decode the bit stream generated by the information encoding apparatus according to claim 1, the information decoding apparatus comprising:
at least one processor or circuit and a memory storing instructions to cause the at least one processor or circuit to perform operations of the following units:
a separation unit configured to acquire the image encoded data, the haptic encoded data, and the pixel value conversion information from the bit stream;
a first decoding unit configured to decode the image encoded data; and
a second decoding unit configured to decode the haptic encoded data, including
a unit configured to decode the difference value having been encoded,
a second conversion unit configured to convert a pixel value decoded by the first decoding unit by using the pixel value conversion information, and
an addition unit configured to add a pixel value converted by the second conversion unit and the difference value having been decoded.

14. The information decoding apparatus according to claim 13, wherein the separation unit includes a header analysis unit configured to analyze header data in which encoding control information necessary for decoding the image encoded data and the haptic encoded data is described.

15. The information decoding apparatus according to claim 14, wherein the second decoding unit decodes a signal obtained by directly encoding the haptic information by the second encoding unit when the pixel value conversion information does not exist.

16. An information encoding method of encoding image information and haptic information, the information encoding method comprising:
executing first encoding of encoding the image information;
executing second encoding of encoding the haptic information, the second encoding including
analyzing of analyzing a correlation between the image information not encoded and the haptic information not encoded,
generating of generating pixel value conversion information that is information for converting a pixel value in the image information not encoded into a conversion pixel value that is a different pixel value based on an analysis result by the analyzing,
calculating of calculating a difference value between a haptic signal value in haptic information and the conversion pixel value corresponding to a same spatial position as the haptic signal value, and
encoding of encoding the difference value; and
executing multiplexing of multiplexing image encoded data encoded by the first encoding, haptic encoded data encoded by the second encoding, and the pixel value conversion information into one bit stream.

17. A non-transitory computer-readable storage medium storing a program for causing a computer to function as each unit of an information encoding apparatus configured to encode image information and haptic information, the information encoding apparatus comprising:
at least one processor or circuit and a memory storing instructions to cause the at least one processor or circuit to perform operations of the following units:
a first encoding unit configured to encode the image information;
a second encoding unit configured to encode the haptic information, the second encoding unit including an analysis unit configured to analyze a correlation between the image information not encoded and the haptic information not encoded,
a generation unit configured to generate pixel value conversion information that is information for converting a pixel value in the image information not encoded into a conversion pixel value that is a different pixel value based on an analysis result by the analysis unit,
a calculation unit configured to calculate a difference value between a haptic signal value in haptic information and the conversion pixel value corresponding to a same spatial position as the haptic signal value, and
an encoding unit configured to encode the difference value; and
a multiplexing unit configured to multiplex image encoded data encoded by the first encoding unit, haptic encoded data encoded by the second encoding unit, and the pixel value conversion information into one bit stream.

18. A non-transitory computer-readable storage medium storing a program for causing a computer to function as each unit of an information decoding apparatus configured to decode the bit stream generated by the information encoding apparatus according to claim 1, the information decoding apparatus comprising:
at least one processor or circuit and a memory storing instructions to cause the at least one processor or circuit to perform operations of the following units:
a separation unit configured to acquire the image encoded data, the haptic encoded data, and the pixel value conversion information from the bit stream;
a first decoding unit configured to decode the image encoded data; and
a second decoding unit configured to decode the haptic encoded data, including
a unit configured to decode the difference value having been encoded,
a second conversion unit configured to convert a pixel value decoded by the first decoding unit by using the pixel value conversion information, and
an addition unit configured to add a pixel value converted by the second conversion unit and the difference value having been decoded.
